(19) United States
(12) Patent Application Publication
(10) Pub. No.: US 2005/0085361 A1
(43) Pub. Date: Apr. 21, 2005

(54) Developing roll

(75) Inventors: Masanori Ishida, Aichi-ken (JP); Naoki Yamaguchi, Komaki-shi (JP); Yasuyuki Hayasaki, Komaki-shi (JP); Shoji Arimura, Komaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/968,998

(22) Filed: Oct. 21, 2004

(30) Foreign Application Priority Data
Oct. 21, 2003 (JP) JP2003-360645

(51) Int. Cl. B25F 5/02; F16C 13/00

(52) U.S. Cl. 492/56

(57) ABSTRACT

A developing roll free from frequent occurrence of an imaging failure such as fog and excellent in durability. The developing roll comprises a shaft (1), a base rubber layer (2) provided on an outer peripheral surface of the shaft (1), and a surface layer (3) provided directly or indirectly via a layer on an outer peripheral surface of the base rubber layer, the surface layer being formed by a material comprising a matrix polymer and adipic acid ester plasticizer.

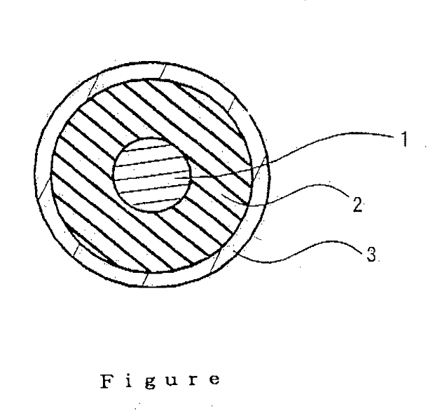

### BACKGROUND OF THE INVENTION

1. Field of the Invention

The present invention relates to a developing roll for use in an electrophotographic apparatus such as a copying machine, a printer or a facsimile machine and, more specifically, to a soft developing roll including a base rubber layer comprising a soft rubber.

2. Description of the Art

In recent years, as a developing roll for use in an electrophotographic apparatus such as a copying machine, a printer or a facsimile machine, a soft developing roll including a base rubber layer comprising a soft rubber has been used for reducing stress imparted on toner, because the size of the toner particles is made smaller for providing sufficiently high image quality and the melting point of the toner is lowered for fixing the toner at a lower temperature. A developing roll, including such a soft developing roll, has the functions to form a uniform toner layer, electrostatically charge the toner and transfer the toner. In order to maintain these functions to the life-end of the apparatus parts, such functions are performed separately by a coating layer having such functions additionally formed on an outer peripheral surface of the soft base layer in many cases (see, for example, Japanese Unexamined Patent Publication No. 2003-15404).

However, the surface layer of the developing roll includes an electrically conductive agent for adjusting electrical resistance, surface roughening particles, a crosslinking agent, a filler and the other many materials for maintaining toner transferability, surface nature and strength to the end of its life. For this reason, the surface of the developing roll is hardened, and tends to impart stress on color toner having a low melting point. Stress causes the problem of fog, which means that toner is scattered in a non-image portion on a paper sheet. In other words, since toner is deteriorated at the end of the life of a toner cartridge so that the developing roll is unevenly electrically charged, which may disturb the copied image or shorten the life itself.

In view of the foregoing, it is an object of the present invention to provide a developing roll which may cause few occurrence of fog and has excellent durability.

### SUMMARY OF THE INVENTION

According to the present invention to achieve the aforesaid objects, there is provided a developing roll comprising a shaft, a base rubber layer provided on an outer peripheral surface of the shaft, and a surface layer provided directly or indirectly via a layer on an outer peripheral surface of the base rubber layer, the surface layer being formed by a material comprising a matrix polymer and an adipic acid ester plasticizer.

The inventors of the present invention have conducted intensive studies centered on a material for forming a surface layer for obtaining a developing roll, which may cause few occurrence of fog and provide excellent durability. They conceived of the idea of adding a plasticizer to the material for forming the surface layer for obtaining a favorable result and continued studies on various plasticizers in detail. As a result, they found that when an adipic acid ester plasticizer is used, the hardness of the developing roll is low and the friction coefficient is decreased, so that toner easily runs on a surface of the developing roll and stress imparted on toner is reduced, which thereby may lower the occurrence of fog. Then, they found that when using the developing roll wherein the surface layer is formed by a material comprising a matrix polymer and an adipic acid ester plasticizer, the above effects can be achieved. Thus, the inventors attained the present invention.

It is believed that the inventive developing roll has the above-mentioned effects because of the following reason. In the inventive developing roll, a surface layer is provided directly or indirectly via a layer on an outer peripheral surface of the base rubber layer, the surface layer is formed by a material comprising a matrix polymer (component (A)) and an adipic acid ester plasticizer (component (B)). For this reason, when the hardness of the surface of the developing roll becomes low, the friction coefficient is decreased so that toner easily runs on a surface of the developing roll. As a result, it is thought that, when using the inventive developing roll, stress imparted on toner is reduced, fog occurrence is lowered and durability is improved.

Especially, when using dibutyl carbitol adipate as the adipic acid ester plasticizer (component (B)), durability is further improved.

When the amount of the adipic acid ester plasticizer (component (B)) is within a specific range, durability is further improved.

### BRIEF DESCRIPTION OF THE DRAWING

The sole FIGURE of the drawing is a sectional view illustrating one embodiment of a developing roll according to the present invention.

### DESCRIPTION OF THE PREFERRED EMBODIMENTS

The present invention will hereinafter be described in detail by way of an embodiment thereof.

A developing roll according to the present invention may, for example, include a shaft 1, a base rubber layer 2 provided on an outer peripheral surface of the shaft 1, and a surface layer 3 provided on an outer peripheral surface of the base rubber layer as shown in the figure.

In the inventive developing roll, the surface layer 3 is formed by a material comprising a matrix polymer (component (A)) and an adipic acid ester plasticizer (component (B)), which is a notable feature of the present invention.

The shaft 1 is not particularly limited, as long as it is electrically conductive, and may be a solid metal core shaft or a hollow cylindrical metal shaft having a hollow interior. The shaft 1 may be composed of aluminum, stainless steel or the like. An adhesive, a primer or the like may be applied on an outer peripheral surface of the shaft 1, as required. Further, the adhesive, the primer or the like may be electrically conductive, as required.

The material for forming the base rubber layer 2 provided on an outer peripheral surface of the shaft 1 is not particularly limited, however, examples thereof include silicone rubber, epichlorohydrin rubber (CO), epichlorohydrin-ethylene oxide copolymer rubber (ECO), acrylonitrile-butadiene rubber (NBR), urethane elastomer, chloroprene rubber, chlorosulfonated polyethylene rubber, an ethylene oxide-propylene oxide copolymer, an ethylene oxide-propylene oxide-allylglycidyl ether copolymer and an epichlorohydrin-ethylene oxide-allylglycidyl ether copolymer rubber, which may be used either alone or in combination. Among these rubbers, silicone rubber, CO, ECO, NBR and urethane elastomer are preferably used because each have low electrical resistance.

Further, the material for forming the base rubber layer 2 may include one or more of an electron conductive agent, an ionic conductive agent, a crosslinking agent, a vulcanizing accelerator, a processing aid, an anti-aging agent, a softener, a reinforcing agent and a foaming agent, as required.

Examples of the electron conductive agent include powdery metals such as aluminum powder and stainless steel powder, electrically conductive metal oxides such as conductive zinc oxide (c-ZnO), conductive titanium dioxide (c-TiO₂), conductive iron oxide (c-Fe₃O₄) and conductive stannic oxide (c-SnO₂), and powdery electrically conductive agents such as graphite and carbon black, which may be used either alone or in combination. Examples of the ionic conductive agent include quaternary ammonium salts, phosphoric esters, sulfonates, aliphatic polyvalent alcohols, and sulfates of aliphatic alcohols, which may be used either alone or in combination.

Further, the surface layer 3 provided on an outer peripheral surface of the base rubber layer 2 is formed by a material comprising a matrix polymer (component (A)) and an adipic acid ester plasticizer (component (B)).

The matrix polymer (component (A)) is not specifically limited, however, examples thereof include rubber or resin materials such as polyurethane based ones, polyamide based ones, silicone based ones, acryl based ones and urea based ones, which may be used either alone or in combination.

The adipic acid ester plasticizer (component (B)) employed with the matrix polymer (component (A)) is not specifically limited, however, examples thereof include dibutyl carbitol adipate, dioctyl adipate and diisobutyl adipate, which maybe used either alone or in combination. Among these plasticizers, dibutyl carbitol adipate is preferably used because an effect can be obtained with addition of a small amount thereof.

The adipicacid ester plasticizer (component (B)) is preferably present in the matrix polymer (component (A)) in a proportion of 5 to 50 parts by weight (hereinafter referred to simply as “parts”), more preferably 10 to 30 parts, based on 100 parts of the matrix polymer. When the proportion is less than 5 parts, the effect for reducing the stress imparted on toner cannot be sufficiently obtained. To the contrary, when the proportion is higher than 50 parts, the plasticizer tends to bleed out on a surface of the developing roll so as to bring about the possibility for smearing the photoreceptor drum.

An electrically conductive agent, a hardener or the like may be blended to the material for forming the surface layer 3 in addition to the components (A) and (B), as required.

The developing roll according to the present invention is produced, for example, in the following manner.

Each component for forming the base rubber layer 2 is kneaded by means of a kneading machine such as a kneader for preparation of the base rubber layer material. Each component for forming the surface layer 3 is kneaded by means of a kneading machine such as a roll and an organic solvent is added thereto so as to be mixed and stirred for preparation of the material of the surface layer. Next, the base rubber layer material is filled into an ejection mold wherein a core metal is provided as a shaft 1, and capped for closing the ejection mold, and then heated at predetermined conditions for crosslinking. Thereafter, the resulting product is unmolded. Thus, the base roll is produced such that the base rubber layer 2 is provided on an outer peripheral surface of the shaft 1. Further, the material for forming the surface layer 3 is coated on an outer peripheral surface of the thus obtained base roll for forming the surface layer. Thus, a two-layer electrically conductive roll wherein the surface layer 3 is formed on an outer peripheral surface of the base rubber layer 2, as shown in the figure, can be manufactured.

The method for forming the base rubber layer 2 is not limited to ejection molding. The base rubber layer 2 may be produced by cast molding, or a method of press molding and then abrading. Further, the method for coating the material for forming the surface layer 3 is not specifically limited, however, examples thereof include conventional methods such as a dipping method, a spray coating method and a roll coating method.

The base rubber layer 2 of the thus obtained developing roll typically preferably has a thickness of 0.5 mm to 10 mm, particularly preferably 1 mm to 6 mm. The surface layer 3 preferably has a thickness of 3 to 100 μm, particularly preferably 5 to 50 μm.

The structure of the inventive developing roll is not limited to the two layer structure wherein the surface layer 3 is formed directly on an outer peripheral surface of the base rubber layer 2, shown in the figure, but the developing roll may be of a multi-layer structure having three or more layers wherein a surface layer 3 is formed via at least one intermediate layer on an outer peripheral surface of the base rubber layer 2. In the case of the developing roll having the multi-layer structure, however, the surface layer 3 should be formed by a material comprising a matrix polymer (component (A)) and an adipic acid ester plasticizer (component (B)).

Next, an explanation will be given to Examples and Comparative Examples.

### EXAMPLE 1

Preparation for Surface Layer Material

A surface layer material was prepared by mixing 100 parts of urethane resin (Nippolan 5230 available from Nippon Polyurethane Industry Co., Ltd. of Tokyo, Japan), 30 parts of carbon black (HS-100 available from DENKI KAGAKU KOGYO KABUSHIKI KAISHA of Tokyo, Japan) and 5 parts of dibutyl carbitol adipate (ADK CIZER RS107 available from Asahi Denka Co., Ltd. of Tokyo, Japan) and stirring the mixture, and dissolving the resulting mixture in methyl ethyl ketone.

Production of Developing Roll

A core metal having a diameter of 10 mm made of SUS 303 was prepared as a shaft 1, and an adhesive was coated on an outer peripheral surface of the core metal, which was positioned within a mold for forming a roll. An electrically conductive silicone rubber (X34-264A/B available from Shin-Etsu Chemical Co., Ltd. of Tokyo, Japan) was cast in a cavity defined by the shaft within the mold, and capped for closing the mold, and then heated for vulcanization at 160° C. for 40 minutes, and thus for forming a base rubber layer having a thickness of 4 mm on the outer peripheral surface of the shaft. The thus obtained shaft provided with the base rubber layer (base roll) was unmolded, and coated with a coating liquid of the above-mentioned surface layer material, and dried and heated for obtaining a two-layer developing roll wherein a surface layer having a thickness of 10 μm was provided on an outer peripheral surface of the base rubber layer as shown in the figure.

### EXAMPLE 2

A surface layer material was prepared in substantially the same manner as in Example 1, except that the amount of dibutyl carbitol adipate was changed to 10 parts. Then, a developing roll was produced in substantially the same manner as in Example 1, except that this surface layer material was employed.

### EXAMPLE 3

A surface layer material was prepared in substantially the same manner as in Example 1, except that the amount of dibutyl carbitol adipate was changed to 20 parts. Then, a developing roll was produced in substantially the same manner as in Example 1, except that this surface layer material was employed.

### EXAMPLE 4

A surface layer material was prepared in substantially the same manner as in Example 1, except that the amount of dibutyl carbitol adipate was changed to 30 parts. Then, a developing roll was produced in substantially the same manner as in Example 1, except that this surface layer material was employed.

### EXAMPLE 5

A surface layer material was prepared in substantially the same manner as in Example 1, except that the amount of dibutyl carbitol adipate was changed to 50 parts. Then, a developing roll was produced in substantially the same manner as in Example 1, except that this surface layer material was employed.

### COMPARATIVE EXAMPLE 1

A surface layer material was prepared in substantially the same manner as in Example 1, except that dibutyl carbitol adipate was not blended. Then, a developing roll was produced in substantially the same manner as in Example 1, except that this surface layer material was employed.

### COMPARATIVE EXAMPLE 2

A surface layer material was prepared in substantially the same manner as in Example 1, except that 5 parts of dioctyl phthalate was employed instead of 5 parts of dibutyl carbitol adipate. Then, a developing roll was produced in substantially the same manner as in Example 1, except that this surface layer material was employed.

The developing rolls of the Examples and the Comparative Examples thus produced were each evaluated for the following characteristic properties in the following manners. The results are shown in Table 1.

Toner Consumption

Each developing roll was incorporated into an electrophotographic apparatus. Color characters with a print ratio of 3% were intermittently outputted one by one at high-temperature and high-pressure conditions of 45° C.×95% RH. The weight of the toner cartridge was measured after 6,000 copies were outputted. The decreased amount was regarded as toner consumption for evaluation.

Toner Concentration

Each developing roll was incorporated into an electrophotographic apparatus. Color characters with a print ratio of 3% were intermittently outputted one by one at high-temperature and high-pressure conditions of 45° C.×95% RH. After 6,000 copies were outputted, toner having reached white portion of the photoreceptor drum was transferred onto a tape, and the toner concentration (the thus obtained toner smear amount) was measured by a Macbeth densitometer.

Photoreceptor Contamination

Each developing roll was pressed onto a photoreceptor drum by means of a load of 1 kg and was allowed to stand at high-temperature and high-pressure conditions of 45° C.×95% RH for specific periods (two weeks and one month). Thereafter, the developing roll was withdrawn and was incorporated into an electrophotographic apparatus for actual printing. The copied image on the part in contact with the developing roll was evaluated. The symbol X indicates that photoreceptor contamination by bleeding was identified, the symbol Δ indicates that photoreceptor contamination was slightly identified, and the symbol ∘ indicates that no photoreceptor contamination was identified.

TABLE 1

| | | | | | Comparative | |
|---|---|---|---|---|---|---|
| Example | | | | | example | |
| 1 | 2 | 3 | 4 | 5 | 1 | 2 |

Toner consumption (g)

| | | | | | | | |
|---|---|---|---|---|---|---|---|
| Black | 120 | 92 | 40 | 40 | 41 | 170 | 150 |
| Cyanogen | 50 | 45 | 41 | 40 | 38 | 60 | 60 |

Toner concentration

| | | | | | | | |
|---|---|---|---|---|---|---|---|
| Black | 0.4 | 0.37 | 0.17 | 0.18 | 0.17 | 0.8 | 0.7 |
| Cyanogen | 0.3 | 0.21 | 0.2 | 0.19 | 0.2 | 0.4 | 0.4 |

Photoreceptor contamination

| | | | | | | | |
|---|---|---|---|---|---|---|---|
| Two weeks | ◯ | ◯ | ◯ | ◯ | Δ | ◯ | ◯ |
| One month | ◯ | ◯ | ◯ | ◯ | Δ | ◯ | ◯ |

As can be understood from the results shown in Table 1, in the developing rolls of the Examples, toner consumption was low and toner smear amount was few, and no photoreceptor contamination was observed, because the surface layer of the Examples employed the specific plasticizer (dibutyl carbitol adipate).

In the developing rolls of the Comparative Example 1, no photoreceptor contamination was observed. However, both toner consumption and toner smear amount were significant, because the surface layer of the Comparative Example 1 did not employ the specific plasticizer (dibutyl carbitol adipate). Since dioctyl phthalate was employed for the surface layer instead of dibutyl carbitol adipate in the developing roll of the Comparative Example 2, both toner consumption and toner smear amount were significant.

As described above, the soft developing roll including a base rubber layer comprising a soft rubber, according to the present invention, may be preferably used for an electrophotographic apparatus such as a copying machine, a printer or a facsimile machine.

1. A developing roll comprising a shaft, a base rubber layer provided on an outer peripheral surface of the shaft, and a surface layer provided directly or indirectly via a layer on an outer peripheral surface of the base rubber layer, the surface layer is formed by a material comprising a matrix polymer and an adipic acid ester plasticizer.

2. A developing roll according to claim 1, wherein the matrix polymer is at least one selected from the group consisting of polyurethane resin, polyamide resin, silicone resin, acrylic resin and urea resin.

3. A developing roll according to claim 1, wherein the adipic acid ester plasticizer is dibutyl carbitol adipate.

4. A developing roll according to claim 2, wherein the adipic acid ester plasticizer is dibutyl carbitol adipate.

5. A developing roll according to claim 1, wherein the adipic acid ester plasticizer is present in an amount of 5 to 50 parts by weight based on 100 parts of the matrix polymer.

6. A developing roll according to claim 2, wherein the adipic acid ester plasticizer is present in an amount of 5 to 50 parts by weight based on 100 parts of the matrix polymer.

7. A developing roll according to claim 3, wherein the adipic acid ester plasticizer is present in an amount of 5 to 50 parts by weight based on 100 parts of the matrix polymer.

8. A developing roll according to claim 4, wherein the adipic acid ester plasticizer is present in an amount of 5 to 50 parts by weight based on 100 parts of the matrix polymer.
